(19) United States
(12) Patent Application Publication
(10) Pub. No.: US 2025/0036445 A1
(43) Pub. Date: Jan. 30, 2025

(54) ENTITLEMENT SERVICE HIERARCHY IN A CLOUD

(71) Applicant: VMware, Inc., Palo Alto, CA (US)

(72) Inventors: Bo LIN, Beijing (CN); Caixia JIANG, Beijing (CN); Xiao LIANG, Beijing (CN); Xi ZENG, Beijing (CN); Qi WU, Beijing (CN)

(21) Appl. No.: 18/451,624

(22) Filed: Aug. 17, 2023

(30) Foreign Application Priority Data
Jul. 24, 2023 (WO) PCT/CN2023/108823

(51) Int. Cl. G06F 9/455; G06F 9/50

(52) U.S. Cl. CPC G06F 9/45558; G06F 9/5072; G06F 2009/45595

(57) ABSTRACT

An example method of entitling software in a cloud includes: receiving, from an entitlement agent of the software, an entitlement request at a first entitlement proxy of an entitlement service executing in the cloud; determining, by the entitlement proxy, an entitlement of the software in response to the entitlement request based on an entitlement specification, the entitlement specification provided by an entitlement root of the entitlement service; and sending, by the entitlement proxy, the entitlement to the entitlement agent for application to the software.

### CROSS-REFERENCE

This application is based upon and claims the benefit of priority from International Patent Application No. PCT/CN2023/108823, filed on Jul. 24, 2023, the entire contents of which are incorporated herein by reference.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtualized infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the virtualized infrastructure supports SDDCs and “as-a-service” products that span across an on-premises data center and one or more public clouds. Running software across multiple clouds can engender complexity in setup, management, and operations. Further, there is a need for centralized control and management of software across the different clouds.

One such complexity is software licensing and product enablement. An entitlement service can execute as a cloud service (e.g., in a public cloud), which entitles software components (“components”) based on subscriptions obtained by the user. The subscriptions provide the user the software licenses and the entitlement service handles the product enablement. An entitlement service can manage entitlement for many software components distributed across the multi-cloud system (e.g., thousands or even millions of software components). An entitlement service executing in a cloud can become a bottleneck to the large number of components, which can make many entitlement requests in parallel.

### SUMMARY

In an embodiment, a method of entitling software in a cloud includes: receiving, from an entitlement agent of the software, an entitlement request at a first entitlement proxy of an entitlement service executing in the cloud; determining, by the entitlement proxy, an entitlement of the software in response to the entitlement request based on an entitlement specification, the entitlement specification provided by an entitlement root of the entitlement service; and sending, by the entitlement proxy, the entitlement to the entitlement agent for application to the software.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a computing system according to embodiments.

FIG. 2 is a block diagram depicting a cloud platform connected to components according to embodiments.

FIG. 3 is a block diagram depicting virtualized infrastructure according to embodiments.

FIG. 4 is a block diagram depicting an entitlement service according to embodiments.

FIG. 5 is a block diagram depicting an example deployment of an entitlement service according to embodiments.

FIG. 6 is a flow diagram depicting a method of registering an endpoint with an entitlement service according to embodiments.

FIG. 7 is a flow diagram depicting a method of entitling a cloud service according to embodiments.

FIG. 8 is a flow diagram depicting a method of entitling a cloud service according to embodiments.

### DETAILED DESCRIPTION

One or more embodiments provide a cloud platform from which various services, referred to herein as “cloud services” are delivered to software endpoints. A cloud platform hosts containers and/or virtual machines (VMs) in which software components can execute, including cloud services and other services and databases as described herein. Cloud services are services provided from a public cloud to software executing in the public cloud, in another public cloud, and/or in an on-premises environment. An “on-premises environment” comprises one or more data centers managed by a user. The user can be a customer of public cloud(s)).

In an embodiment, the cloud services include an entitlement service configured to deliver entitlements to endpoints executing in the public cloud, in another public cloud, and/or in an on-premises environment. The entitlement service comprises a cloud service having a component hierarchy. A component is an instance of the cloud service that executes concurrently with other components of the cloud service. The components of the entitlement service include a root component (“entitlement root”) and a plurality of proxy components (“entitlement proxies”). The components of the entitlement service execute at different levels of the hierarchy, which include a root level and one or more levels subordinate to the root level. The entitlement root executes at the root level and the entitlement proxies execute in the subordinate level(s). Within a subordinate level, the entitlement proxies therein can execute in geographically diverse locations.

Each endpoint is connected to one of the entitlement service components. An entitlement comprises data that entitles an endpoint based on terms of a license. An entitlement can activate an endpoint, enabling feature(s) of an endpoint, disabling feature(s) of an endpoint, and the like type activities associated with software licensing. The entitlement service entitles a target endpoint through an entitlement agent, which receives entitlements from the entitlement service and applies the entitlements to the target endpoint. The entitlement agent comprises a portion of the target endpoint or software separate from the target endpoint. Embodiments of the cloud platform are described below with respect to the drawings.

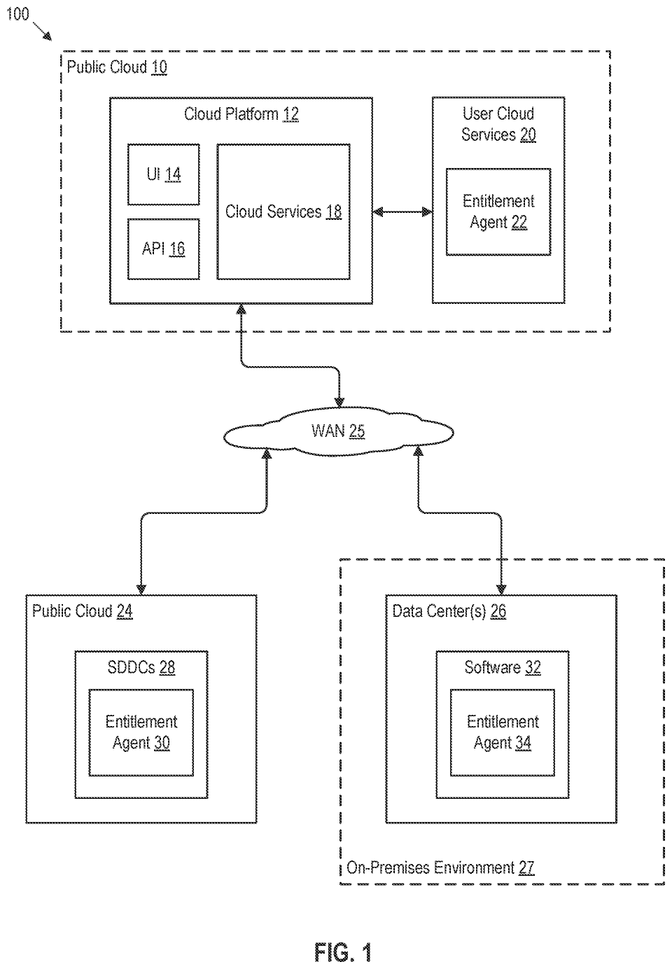

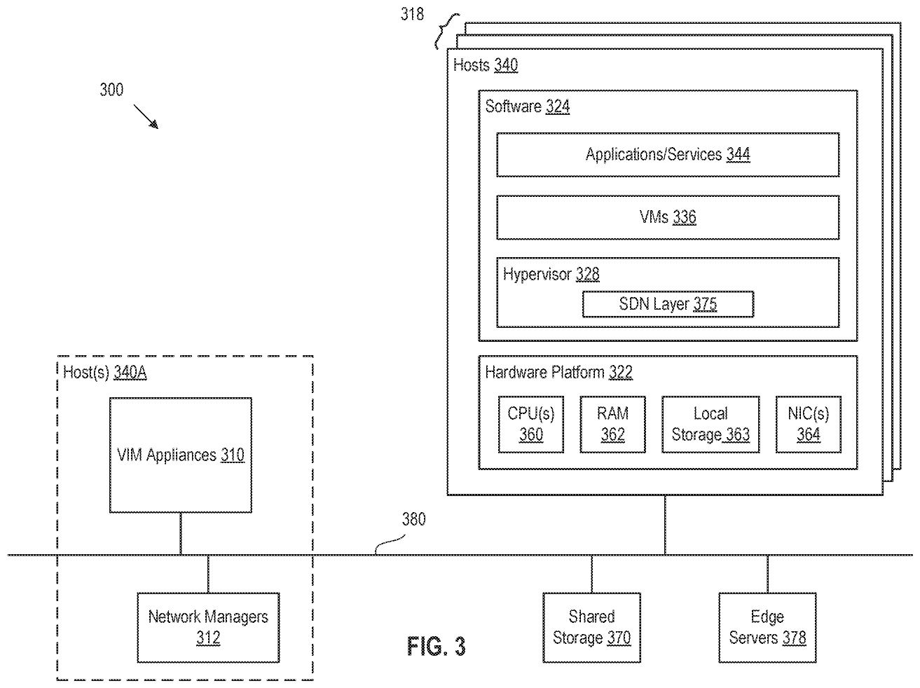

FIG. 1 is a block diagram depicting a computing system 100 according to embodiments. Computing system 100 includes a cloud platform 12 in a public cloud 10. Cloud platform 12 includes software executing on virtualized infrastructure of public cloud 10. Example virtualized infrastructure is shown in FIG. 3. The software of cloud platform 12 includes cloud services 18. A user interface (UI) or an application programming interface (API) that interacts with cloud services 18 are depicted in FIG. 1 as UI 14 and API 16, respectively. A user can interact with cloud services 18 through UI 14. The user can be a customer of public cloud 10 or part of an organization that is a customer of public cloud 10 (e.g., public cloud is managed by another organization). Software can interact with cloud services 18 through API 16. UI 14 can be a separate software component from cloud services 18. Alternatively, all or a portion of UI 14 can be part of one or more of cloud services 18. Likewise, API 16 can be part of a separate software component from cloud services 18. Alternatively, all or a portion of API 16 can be part of one or more of cloud services 18. Cloud services 18 are hosted by containers and/or virtual machines (VMs) supported by the virtualized infrastructure of public cloud 10.

Cloud platform 12 is connected to components, which can include user cloud services 20 executing in public cloud 10, SDDCs 28 in a public cloud 24, and/or software 32 executing in data center(s) 26 of an on-premises environment 27. User cloud services 20 comprise cloud services, separate from cloud platform 12, provided to the user by public cloud 10. Cloud services 18 can manage user cloud services 20 through agents, which can be software separate from user cloud services 20 or can be part of user cloud services 20. In embodiments, user cloud services 20 include enforcement agents 22 used for software/service entitlements. Cloud platform 12 communicates with user cloud services 20 through a network of public cloud 10.

Cloud platform 12 communicates with SDDCs 28 and software 32 through networks of public cloud 10, public cloud 24, and data center(s) 26, all of which are connected to a wide area network (WAN) 25, such as the public Internet. SDDCs 28 are provided to the user by public cloud 24, which can be separate from public cloud 10 (e.g., public cloud 24 can be managed by a different organization than public cloud 10). Cloud services 18 can manage SDDCs 28 through agents, which comprise software executing in SDDCs 28. In embodiments, SDDCs 28 include enforcement agents 30 used for software entitlements. Cloud services 18 can manage software 32 through agents, which can be software separate from software 32 or can be part of software 32. In embodiments, data center(s) 26 include enforcement agents 34 used for software entitlements.

An example cloud service 18 comprises an entitlement service configured to provide entitlements for licensing target endpoints. Example target endpoints include user cloud services 20, SDDCs 28, and software 32. The entitlement service interacts with entitlement agents 33, 30, and 34.

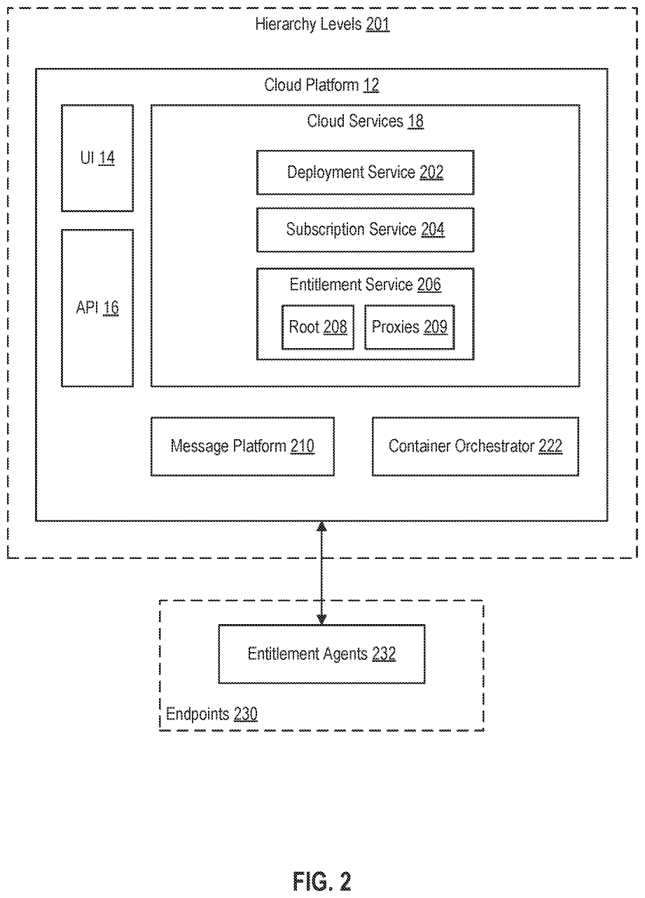

FIG. 2 is a block diagram depicting a cloud platform 12 connected to components 230 according to embodiments. Cloud services 18 of cloud platform 12 include deployment service 202, subscription service 204, and entitlement service 206. Entitlement service 206 comprises an entitlement root 208 and entitlement proxies 209. Cloud platform 12 includes software that supports cloud services 18, including event streaming platform 210, workflow orchestrator 212, ingress controllers 214, database 221, and container orchestrator 222. Software of cloud platform 12 can store data in cloud storage 220, which includes any type or persistent storage.

A user or software interacts with subscription software 204 through UI 14 or API 16, respectively, to obtain subscriptions for components 230 (e.g., purchased according to any business model). A subscription includes a license that entitles a target component. Subscription service 204 notifies deployment service 202 of the subscriptions. Deployment service 202 generates entitlement specifications for the subscriptions. Deployment service 202 supplies the entitlement specifications to entitlement service 206, which delivers entitlements based on the entitlement specifications to entitlement agents 232. Entitlement agents 232 apply the entitlements to endpoints 230. An entitlement agent 232 can be part of an endpoint 230, e.g., logic of a endpoint 230 accessed through an API. An entitlement agent 232 can be software separate from an endpoint 230, e.g., a license manager that accesses an API of an endpoint 230. Example endpoints 230 are shown in FIG. 1 described above and include user cloud services 20, SDDCs 28, and software 32. Communication between entitlement service 206 and entitlement agents 232 may be implemented using a remote procedure call (RPC) protocol, such as gRPC or a derivative of gRPC. gRPC is open-source software available on the public Internet.

In embodiments, deployment service 202 delivers entitlement specifications to entitlement service 206 through message platform 210. Message platform 210 decouples deployment service 202 from entitlement service 206. Deployment service 202 functions as a provider to message platform 210 and entitlement service 206 functions as a consumer of message platform 210. An example message platform 210 is KAFKA or a derivative of KAFKA. KAFKA is open-source software available on the public Internet.

In embodiments, cloud services 18, including deployment service 202, subscription service 204, and entitlement service 206 comprise services hosted by containers (i.e., containerized services). Containers utilize operating system (OS) virtualization to isolate processes and control processes' access to host hardware. The OS virtualized by containers can be a guest OS of a VM or a host OS executing directly on a host. The containers implementing cloud services 18 can be managed by a container orchestrator 222, which is configured to create, deploy, redeploy, destroy, etc. the containers. An example container orchestrator 222 is KUBERNETES or a derivative thereof. KUBERNETES is open-source software available on the public Internet. A user or software can interact with container orchestrator 222 to manage entitlement service 206.

FIG. 3 is a block diagram depicting virtualized infrastructure 300 according to embodiments. Virtualized infrastructure 300 or variants thereof can be used to support cloud platform 12, SDDCs 28, and software 32 shown in FIG. 1. Virtualized infrastructure 300 includes a cluster of hosts 340 (“host cluster 318”) that may be constructed on hardware platforms such as an x86 architecture platforms or ARM platforms. For purposes of clarity, only one host cluster 318 is shown. However, virtualized infrastructure 300 can include many of such host clusters 318. As shown, a hardware platform 322 of each host 340 includes conventional components of a computing device, such as one or more central processing units (CPUs) 360, system memory (e.g., random access memory (RAM) 362), one or more network interface controllers (NICs) 364, and optionally local storage 363. CPUs 360 are configured to execute instructions, for example, executable instructions that perform one or more operations described herein, which may be stored in RAM 362. NICs 364 enable host 340 to communicate with other devices through a physical network 380. Physical network 380 enables communication between hosts 340 and between other components and hosts 340.

In the embodiment illustrated in FIG. 3, hosts 340 access shared storage 370 by using NICs 364 to connect to network 380. In another embodiment, each host 340 contains a host bus adapter (HBA) through which input/output operations (IOs) are sent to shared storage 370 over a separate network (e.g., a fibre channel (FC) network). Shared storage 370 include one or more storage arrays, such as a storage area network (SAN), network attached storage (NAS), or the like. Shared storage 370 may comprise magnetic disks, solid-state disks, flash memory, and the like as well as combinations thereof. In some embodiments, hosts 340 include local storage 363 (e.g., hard disk drives, solid-state drives, etc.). Local storage 363 in each host 340 can be aggregated and provisioned as part of a virtual SAN, which is another form of shared storage 370.

Software 324 of each host 340 provides a virtualization layer, referred to herein as a hypervisor 328, which directly executes on hardware platform 322. In an embodiment, there is no intervening software, such as a host operating system (OS), between hypervisor 328 and hardware platform 322. Thus, hypervisor 328 is a Type-1 hypervisor (also known as a “bare-metal” hypervisor). As a result, the virtualization layer in host cluster 318 (collectively hypervisors 328) is a bare-metal virtualization layer executing directly on host hardware platforms. Hypervisor 328 abstracts processor, memory, storage, and network resources of hardware platform 322 to provide a virtual machine execution space within which multiple virtual machines (VM) 336 may be concurrently instantiated and executed. Applications and services 344 execute in VMs 336 (e.g., including containerized services).

Host cluster 318 is configured with a software-defined (SDN) layer 375. SDN layer 375 includes logical network services executing on virtualized infrastructure in host cluster 318. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized infrastructure 300 includes edge servers 378 that provide an interface of host cluster 318 to WAN 25.

A VIM appliance 310 is a non-virtualized or virtual server that manages host cluster 318 and the virtualization layer therein. VIM appliance 310 installs agent(s) in hypervisor 328 to add a host 340 as a managed entity. VIM appliance 310 logically groups hosts 340 into host cluster 318 to provide cluster-level functions to hosts 340, such as VM migration between hosts 340 (e.g., for load balancing), distributed power management, dynamic VM placement according to affinity and anti-affinity rules, and high availability. The number of hosts 340 in host cluster 318 may be one or many. VIM appliance 310 can manage more than one host cluster 318. Virtualized infrastructure 300 can include more than one VIM appliance 310, each managing one or more host clusters 318.

In an embodiment, virtualized infrastructure 300 further includes a network manager 312. Network manager 312 (another management appliance) is a non-virtualized or virtual server that orchestrates SDN layer 375. In an embodiment, network manager 312 comprises one or more virtual servers deployed as VMs. Network manager 312 installs additional agents in hypervisor 328 to add a host 340 as a managed entity. In embodiments, VIM appliances 310 and network managers 312 execute on hosts 340A, which are selected ones of hosts 340 and which form a management cluster.

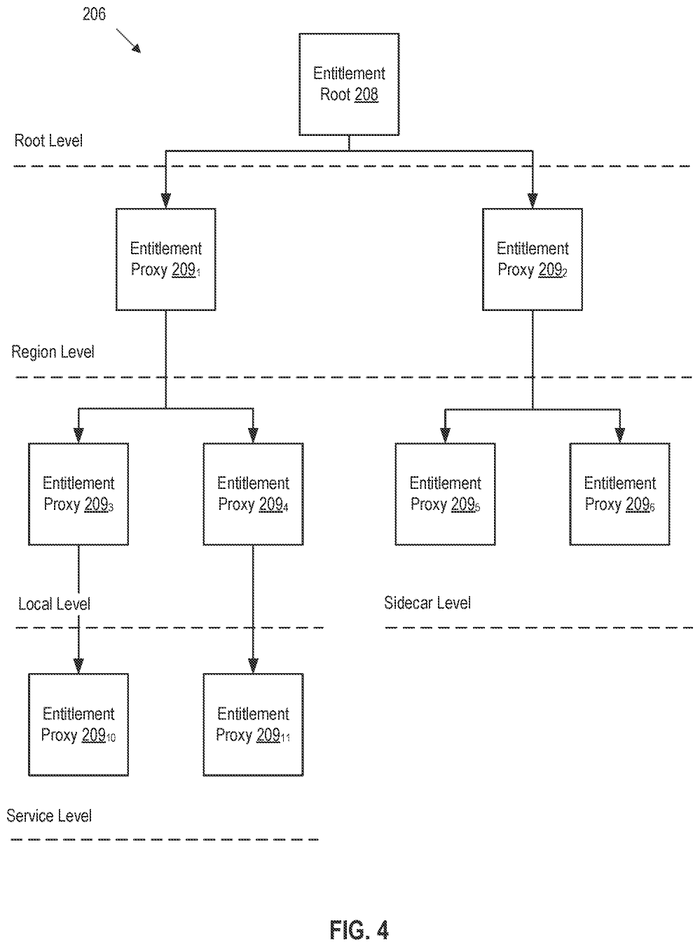

FIG. 4 is a block diagram depicting an entitlement service according to embodiments. Entitlement service 206 comprises a plurality of components, including an entitlement root 208 and entitlement proxies 209. The components are part of a hierarchy having a plurality of levels. Entitlement root 208 executes at a root level. Entitlement proxies 209₁ and 209₂ execute at a region level. Entitlement proxies 209 in the region level can be geographically disperse based on regions, e.g., North America West and North America East. Entitlement root 208 provides entitlement specifications to entitlement proxies 209₁ and 209₂.

Entitlement proxies 209₃ and 209₄ execute at a local level of the hierarchy. The local level can be subordinate to the region level (e.g., North East and South East within the East region. Entitlement proxies 209₁₀ and 209₄ receive entitlement specifications from entitlement proxy 209₁. Entitlement proxies 209₁₀ and 209₁ execute at a service level of the hierarchy. The service level can be subordinate to another level (e.g., the local level in FIG. 4) and pertain to different service types. For example, entitlement proxy 209₁₀ can be responsible for entitling services of a particular type within the locality serviced by entitlement proxy 209₃ (e.g., services of type A in North East). Entitlement proxy 209₁₁ can be responsible for entitling services of a particular type within the locality serviced by entitlement proxy 209₄ (e.g., services of type B in South East). Entitlement proxies 209₅ and 209₆ execute at a sidecar level of the hierarchy. By “sidecar” it is meant that the entitlement proxies execute alongside the endpoints (e.g., on the same servers, same virtual machines, same containers, etc.).

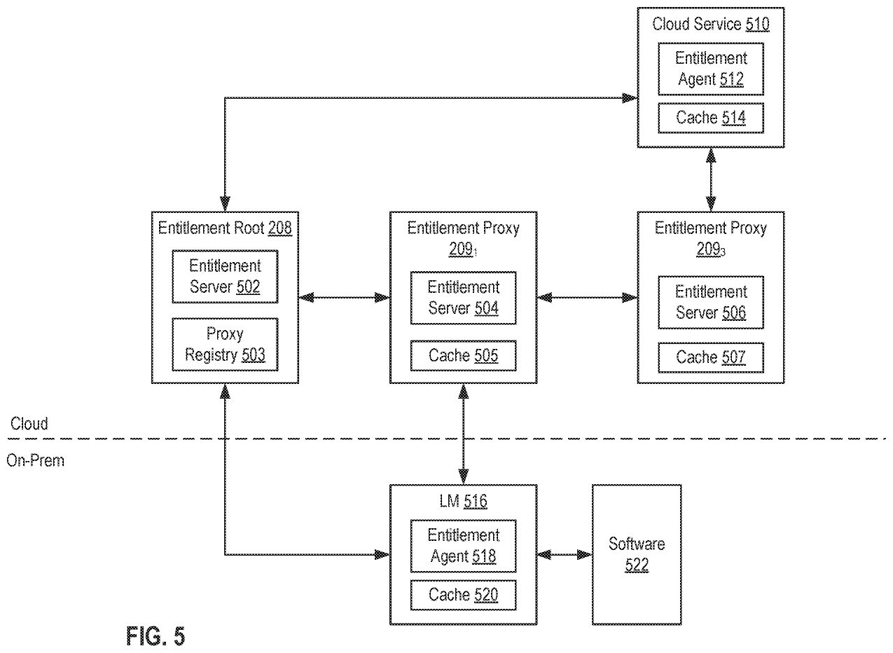

FIG. 5 is a block diagram depicting an example deployment of an entitlement service according to embodiments. In the embodiment, entitlement service 206 includes entitlement root 208 and entitlement proxies 209₁ and 209₃. Entitlement proxy 209₁ executes at a region level subordinate to the root level. Entitlement proxy 209₃ executes at a local level subordinate to the region level. Entitlement root 208 includes entitlement server 502 and proxy registry 503. Entitlement server 502 is configured to receive requests and generate entitlement specifications in response to the requests. Proxy registry 503 is configured to manage the entitlement proxies of entitlement service 206 (e.g., which proxies are at which levels, their identity information, etc.).

Entitlement proxy 209₁ includes entitlement server 504 and cache 505. Entitlement server 504 receives entitlement specifications from entitlement root 208 and requests from entitlement agents. Cache 505 can store entitlement specifications on a temporary basis with a time-to-live (TTL) value. Likewise, entitlement proxy 209₃ includes entitlement server 506 and cache 507. Entitlement server 506 receives entitlement specifications from entitlement proxy 209₁ and requests from entitlement agents. Cache 507 can store entitlement specifications on a temporary basis with a TTL value.

A cloud service 510 includes an entitlement agent 512 and a cache 514. Cloud service 510 registers with entitlement proxy 209₃. For example, cloud service 510 can execute within a locality serviced by entitlement proxy 209₃ (e.g., Northeast locality within an East region). Entitlement agent 512 sends entitlement requests on behalf of cloud service 510 to entitlement server 506 and receives entitlement responses from entitlement server 506. Entitlement agent 512 can also send a registration request to entitlement server 502 of entitlement root 208 in order to locate the entitlement proxy with which to communicate (e.g., entitlement proxy 209₃). Cache 514 can store entitlements received from entitlement proxy 209₃ on a temporary basis with a TTL.

Similar to cloud service 510, a license manager (LM) 516 executing in an on-prem environment can include an entitlement agent 518 and a cache 520. For example, LM 516 can execute within a locality serviced by entitlement proxy 209₁ (e.g., East region). Entitlement agent 518 sends entitlement requests on behalf of software 522 to entitlement server 504 and receives entitlement responses from entitlement server 504. Entitlement agent 518 can also send a registration request to entitlement server 502 of entitlement root 208 in order to locate the entitlement proxy with which to communicate (e.g., entitlement proxy 209₁). Cache 520 can store entitlements received from entitlement proxy 209₁ on a temporary basis with a TTL.

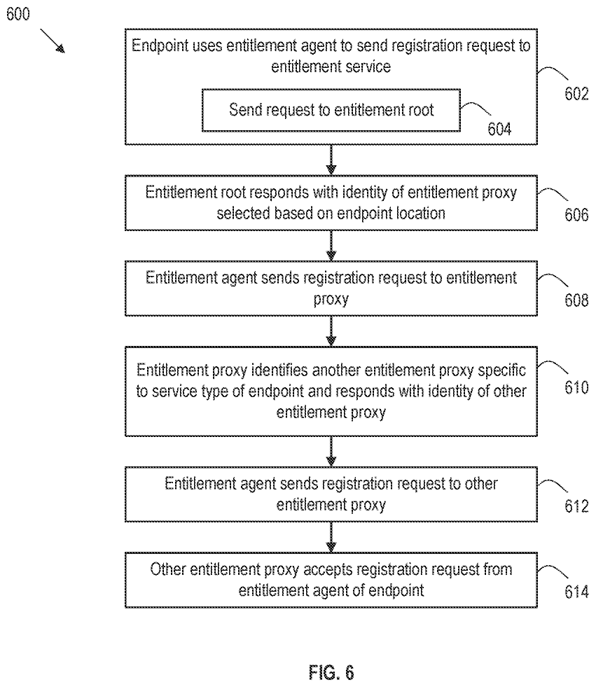

FIG. 6 is a flow diagram depicting a method 600 of registering an endpoint with an entitlement service according to embodiments. Method 600 begins at step 602, where an endpoint uses its enforcement agent to send a registration request to entitlement service 206. In particular, at step 604, the entitlement agent sends the request to entitlement root 208. At step 606, entitlement root 208 responds with the identity of an entitlement proxy selected based on the endpoint's location. At step 608, the entitlement agent sends a registration request to the entitlement proxy.

In the example of FIG. 6, assume the endpoint comprises a cloud service of a particular type. Assume further that there is an entitlement proxy for this specific type of service. Thus, at step 610, the entitlement proxy identifies another entitlement proxy specific to the service type of the endpoint and responds with the identity of the other entitlement proxy. In the example of FIG. 5, cloud service 510 sends a registration request to entitlement root 208, which identifies entitlement proxy 209₁ (step 606). Cloud service 510 then sends a registration request to entitlement proxy 209₁, which identifies entitlement proxy 209₃ (assuming in this example entitlement proxy 209₃ handles that service type) (step 610).

At step 612, the entitlement agent sends a registration request to the other entitlement proxy (the service-specific entitlement proxy). At step 614, the other entitlement proxy accepts the registration request from the entitlement agent of the endpoint.

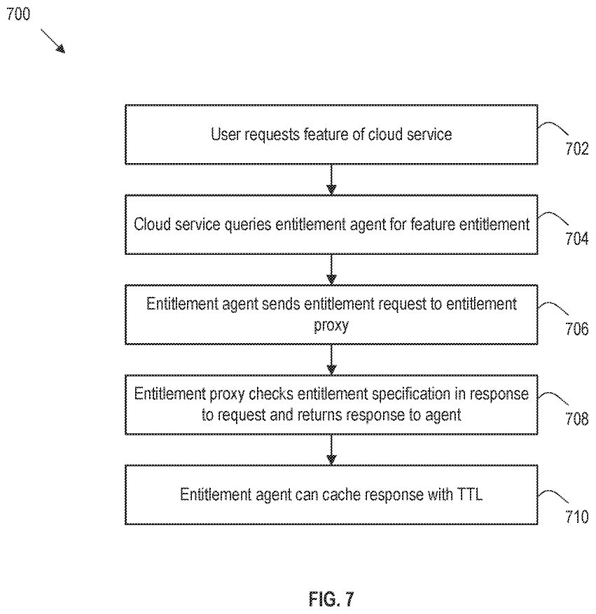

FIG. 7 is a flow diagram depicting a method 700 of entitling a cloud service according to embodiments. Method 700 begins at step 702, where the user requests a feature of a cloud service. At step 704, the cloud service queries its entitlement agent for whether the feature is entitled. At step 706, the entitlement agent sends an entitlement request to its entitlement proxy with which it is registered. At step 708, the entitlement proxy checks the entitlement specification for the cloud service in response to the request and returns a response to the agent. At step 710, the entitlement agent can cache the response with a TTL. The entitlement agent can use the cached response for future user requests received during the TTL without having to communicate with the entitlement proxy. The entitlement either allows or disallows the feature from being used based on the entitlement specification, which was generated based on a subscription.

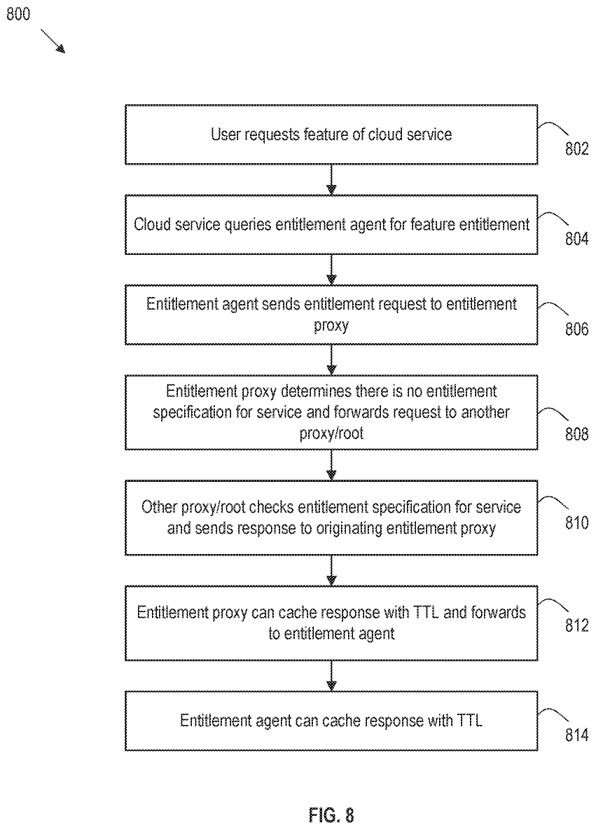

FIG. 8 is a flow diagram depicting a method 800 of entitling a cloud service according to embodiments. Method 800 begins at step 802, where the user requests a feature of a cloud service. At step 804, the cloud service queries its entitlement agent for whether the feature is entitled. At step 806, the entitlement agent sends an entitlement request to its entitlement proxy with which it is registered. At step 808, the entitlement proxy determines that there is no entitlement specification for the cloud service and forwards the request to another entitlement proxy or to the entitlement root (depending on the hierarchy of the entitlement service). At step 810, the other proxy/root checks the entitlement specification for the cloud server and sends an entitlement response to the originating entitlement proxy. At step 812, the entitlement proxy can cache the entitlement response with a TTL and forwards the response to the entitlement agent of the cloud service. At step 814, the entitlement agent can cache the response with a TTL. The entitlement either allows or disallows the feature from being used based on the entitlement specification, which was generated based on a subscription.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of entitling software in a cloud, comprising:
receiving, from an entitlement agent of the software, an entitlement request at a first entitlement proxy of an entitlement service executing in the cloud;
determining, by the entitlement proxy, an entitlement of the software in response to the entitlement request based on an entitlement specification, the entitlement specification provided by an entitlement root of the entitlement service; and
sending, by the entitlement proxy, the entitlement to the entitlement agent for application to the software.

2. The method of claim 1, further comprising:
receiving, by the entitlement root, a registration request from the entitlement agent;
sending, by the entitlement root, an identity of the first entitlement proxy to the entitlement agent in response to the registration request.

3. The method of claim 2, wherein the entitlement root selects the first entitlement proxy based on location of infrastructure on which the software executes.

4. The method of claim 2, further comprising:
receiving, by the entitlement root, a registration request from the entitlement agent;
sending, by the entitlement root, an identity of a second entitlement proxy to the entitlement agent in response to the registration request;
receiving, at the second entitlement proxy, the registration request from the entitlement agent;
sending, by the second entitlement proxy, an identity of the first entitlement proxy based on a type of the software.

5. The method of claim 1, further comprising:
determining, at the first entitlement proxy, absence of the entitlement specification;
sending, by the first entitlement proxy, a request for the entitlement specification to a second entitlement proxy or the entitlement root for the entitlement specification; and
caching, at the first entitlement proxy, the entitlement specification as received from the second entitlement proxy or the entitlement root.

6. The method of claim 1, wherein the software comprises a cloud service.

7. The method of claim 1, wherein the software executes in an on-premises environment.

8. A non-transitory computer readable medium comprising instructions to be executed in a computing device to cause the computing device to carry out a method of entitling software in a cloud, comprising:
receiving, from an entitlement agent of the software, an entitlement request at a first entitlement proxy of an entitlement service executing in the cloud;
determining, by the entitlement proxy, an entitlement of the software in response to the entitlement request based on an entitlement specification, the entitlement specification provided by an entitlement root of the entitlement service; and
sending, by the entitlement proxy, the entitlement to the entitlement agent for application to the software.

9. The non-transitory computer readable medium of claim 8, further comprising:
receiving, by the entitlement root, a registration request from the entitlement agent;
sending, by the entitlement root, an identity of the first entitlement proxy to the entitlement agent in response to the registration request.

10. The non-transitory computer readable medium of claim 9, wherein the entitlement root selects the first entitlement proxy based on location of infrastructure on which the software executes.

11. The non-transitory computer readable medium of claim 9, further comprising:
receiving, by the entitlement root, a registration request from the entitlement agent;
sending, by the entitlement root, an identity of a second entitlement proxy to the entitlement agent in response to the registration request;
receiving, at the second entitlement proxy, the registration request from the entitlement agent;
sending, by the second entitlement proxy, an identity of the first entitlement proxy based on a type of the software.

12. The non-transitory computer readable medium of claim 8, further comprising:
determining, at the first entitlement proxy, absence of the entitlement specification;
sending, by the first entitlement proxy, a request for the entitlement specification to a second entitlement proxy or the entitlement root for the entitlement specification; and
caching, at the first entitlement proxy, the entitlement specification as received from the second entitlement proxy or the entitlement root.

13. The non-transitory computer readable medium of claim 8, wherein the software comprises a cloud service.

14. The non-transitory computer readable medium of claim 8, wherein the software executes in an on-premises environment.

15. A computing system, comprising:
a cloud platform executing in a public cloud, the cloud platform including an entitlement service having an entitlement root and a first entitlement proxy;
software, executing on infrastructure, having an entitlement agent;
the entitlement proxy configured to:
receive, from the entitlement agent, an entitlement request;
determine an entitlement of the software in response to the entitlement request based on an entitlement specification, the entitlement specification provided by the entitlement root of the entitlement service; and
send the entitlement to the entitlement agent for application to the software.

16. The computing system of claim 15, wherein the entitlement root is configured to:
receive a registration request from the entitlement agent;
send an identity of the first entitlement proxy to the entitlement agent in response to the registration request.

17. The computing system of claim 16, wherein the entitlement root selects the first entitlement proxy based on location of infrastructure on which the software executes.

18. The computing system of claim 16, wherein the entitlement root is configured to:
receive a registration request from the entitlement agent;
send an identity of a second entitlement proxy to the entitlement agent in response to the registration request;
and wherein the second entitlement proxy is configured to:
receive the registration request from the entitlement agent;
send an identity of the first entitlement proxy based on a type of the software.

19. The computing system of claim 15, wherein the first entitlement proxy is configured to:
determine absence of the entitlement specification;
send a request for the entitlement specification to a second entitlement proxy or the entitlement root for the entitlement specification; and
cache the entitlement specification as received from the second entitlement proxy or the entitlement root.

20. The method of claim 1, wherein the software comprises a cloud service or executes in an on-premises environment.
